(19) United States
(12) Patent Application Publication
(10) Pub. No.: US 2005/0211052 A1
(43) Pub. Date: Sep. 29, 2005

(54) Guitar having a metal plate insert

(76) Inventor: Patrick James Gigliotti, Tacoma, WA (US)

Correspondence Address: David L. Garrison;Garrison & Associates PS, Suite 3300, 2001 Sixth Avenue, Seattle, WA, 98121-2522, US

(21) Appl. No.: 11/092,293

(22) Filed: Mar. 28, 2005

Related U.S. Application Data
(60) Provisional application No. 60/557,178, filed on Mar. 29, 2004.

(51) Int. Cl. G10D 3/00

(52) U.S. Cl. 84/290

(57) ABSTRACT

A body for a guitar or other musical instrument and a method for construction of a guitar body is disclosed, for a guitar having a metal front deck plate insert that provides new and unique acoustic properties and aesthetic appearance. The guitar is essentially comprised of a body, a neck projecting from the body, strings stretched over the body and the neck and a pick-up attached to the body under the strings for producing an electric signal representative of vibrations of the strings, wherein the body has a body frame, a center block, a back deck plate, and a metal front deck plate insert, securely attached at its center and flexibly attached to the guitar body at its perimeter, finished with a brushed or swirl pattern, mounted on the face of the body, whereby the guitar produces a unique resonant tone while played and a constantly changing look as the finished metal catches and reflects light.

### TECHNICAL FIELD

This invention relates generally to stringed musical instruments, and more particularly to a guitar having a body with a metal plate insert as a front deck plate that provides unique acoustic properties and light-reflecting visual properties.

### BACKGROUND OF THE INVENTION

A guitar generally comprises a body, a neck projecting from the body, and strings stretched over the body and the neck. A body can be a solid structure or a hollow or semi-hollow acoustical structure, and is typically formed of wood or plastic.

Principal among the many factors that dominate the design process of both electric and acoustic guitars are acoustical quality and aesthetic qualities. The acoustical quality of an instrument depends heavily on the construction of the instrument body. Design factors that affect the sound of a guitar primarily include the body material (traditionally wood or plastic), as well as the existence and properties of hollow cavities within the guitar body. The aesthetic elements include design features such as the overall body shape, and also include other features that are applied as a post-assembly operation, such as painting and additional ornamentation that is added to the assembled body.

As is known in the art of guitar construction, electric guitar bodies are usually cut from solid wood, then formed into the desired overall shape, machined to produce space for pickups, audio jack, and other electrical components, and then painted with one or more colors in varying detail to obtain the desired aesthetic finish. In these solid body constructions, a cavity may also be machined for insertion of a metal sustain bar, as is well known in the art, that gives the finished guitar an improved sound. Aesthetic qualities of the guitar may be improved with the application of a wide variety of paint schemes or pre-finished phenolic laminates to cover the body.

For semi-hollow guitar bodies, the process is somewhat more complicated. Typically, a semi-hollow guitar body will include an outer rim made of plywood or a solid piece of wood. A longitudinally oriented center block is then inserted within the rim, followed by top and bottom sheets of plywood or solid wood that are attached on either side of the rim and the center block. This produces a guitar body with internal body cavities, one of which is accessed by a cutout made in the top cover plate. Pickups, audio jack, and volume and other controls are mounted on a pick guard, which is secured in place over the cutout in the top of the cover plate. Thereafter, the entire body is finished, typically by painting.

While guitar bodies are customarily formed of wood, some guitar makers have begun to use alternative materials. U.S. Pat. No. 4,290,336 discloses a guitar neck and body made from moldable materials such that the finished guitar may be made solid, semi-solid, or substantially hollow in order to provide a finished article that can be durable and require fewer manufacturing processes. U.S. Pat. No. 6,114,616 discloses a body for a guitar or other musical instrument that has top and bottom pre-finished phenolic laminates to which a cover plate is attached. However, these two patents do not teach the use of a metal in a guitar body for altering the acoustic or aesthetic qualities for the appearance of a guitar.

U.S. Pat. No. 6,255,567 discloses an electric guitar with a body having a body frame constructed of a metal alloy or synthetic resin and fixedly accommodated in the inner space of the body frame and deck plates adhered to both surfaces of the body frame that enables a manufacturer to produce the body through a more simplified, lower cost process. However, this patent teaches the use of metal in guitar building only for use in the construction of a frame for the body, and not for the purpose of providing for the acoustic or aesthetic qualities of a guitar.

U.S. Pat. No. 6,233,825 discloses a metallic stringed musical instrument body and a method for its construction using machining techniques to produce a hollow body or solid body instrument using metallic materials. The construction technique is said to allow for unlimited body designs and modifications to provide a sound customized for the customer. This disclosure does not, however, teach the use of metal to form a body top plate to produce a unique sound or to provide a new appearance of the instrument.

Musicians continue to place demands on makers of musical instruments for new products with unique and improved acoustic and aesthetic qualities. Accordingly, there exists a need for a guitar that produces a unique and improved sound, and a new look through use of alternative building materials such as metal.

### SUMMARY OF THE INVENTION

It is an object of the present invention to provide a new and unique sounding and unique looking guitar having a guitar body that combines special inner chambers with a metal insert laminated onto the guitar face to form a metal front deck plate.

Accordingly, the present invention discloses a guitar and a method for construction of a guitar having a metal front deck plate insert that provides new and unique acoustic properties and aesthetic appearance. The guitar is essentially comprised of a body, a neck projecting from the body, strings stretched over the body and the neck and a pick-up attached to the body under the strings for producing an electric signal representative of vibrations of the strings, wherein the body has a body frame, a center block, a back deck plate, and a metal front deck plate insert, which preferably is securely attached at its center and flexibly attached at its perimeter, finished with a brushed or swirl pattern, mounted on the face of the body, whereby the guitar produces a unique resonant tone while played and a constantly changing look as the finished metal catches and reflects light.

### BRIEF DESCRIPTION OF THE DRAWINGS

FIG. 1 is a plan view of a metal front deck plate of the present invention for a guitar body of a solid-body type guitar.

FIG. 2 is a plan view of the guitar body of the solid-body type guitar showing the guitar body interior.

FIG. 3 is a plan view of a metal front deck plate of the present invention for a guitar body of a hollow-body type guitar.

FIG. 4 is a plan view of the metal front deck plate for a guitar body of a hollow-body type guitar showing alternative locations and orientation of holes for surface components on the metal front deck plate, particularly those for alternative pickups.

FIG. 5 is a plan view of the guitar body of a hollow-body type guitar showing the guitar body interior.

FIG. 6 is a cross-section view of a guitar body of the present invention showing orientation and points of attachment of the metal front deck plate.

FIG. 6a is a partial cross-section view of the guitar body of FIG. 6 showing a detailed view of the attachment of the edge of the metal front deck plate to the guitar body side.

### DETAILED DESCRIPTION OF THE INVENTION

Most electric guitars are essentially comprised of a guitar body, a neck projecting from the body, strings stretched over the body and the neck, the neck having common fingerboard enabling a musician to change the sound of the strings and a means of tensioning the strings in order to tune the guitar, and a pick-up attached to the body under the strings for converting mechanical vibrations produced by the strings into electrical signals corresponding to music played on the guitar. The neck, fingerboard, strings and means of tensioning the strings for the guitar of the present invention are produced by construction methods and techniques that are well known in the art of guitar design and fabrication, such as those produced by guitar manufacturer Fender and other manufacturers. The guitar body that is the focus of the present invention has a body frame, a center block, a back deck plate, and a metal front deck plate insert that is securely attached at its center and preferably is flexibly attached at its perimeter. The metal plate produces a unique resonant tone while the guitar is played and provides a constantly changing look as the finished metal catches and reflects light.

Construction of a guitar body of the present invention is similar to that for an acoustic guitar in which a wooden top of the body is attached by gluing it into a ledge created by the sides of a guitar body and internal braces. A significant difference with the present invention is that the top of the body is made of metal and is attached to the guitar body by using a silicone adhesive, or the like, to secure the top into the ledge, and by locking the top center to a center block by the bridge, so that the top is capable of resonating like a bell.

Referring now to the drawings, the features and advantages of a guitar body having a metal front deck plate insert will be more clearly understood from the following description.

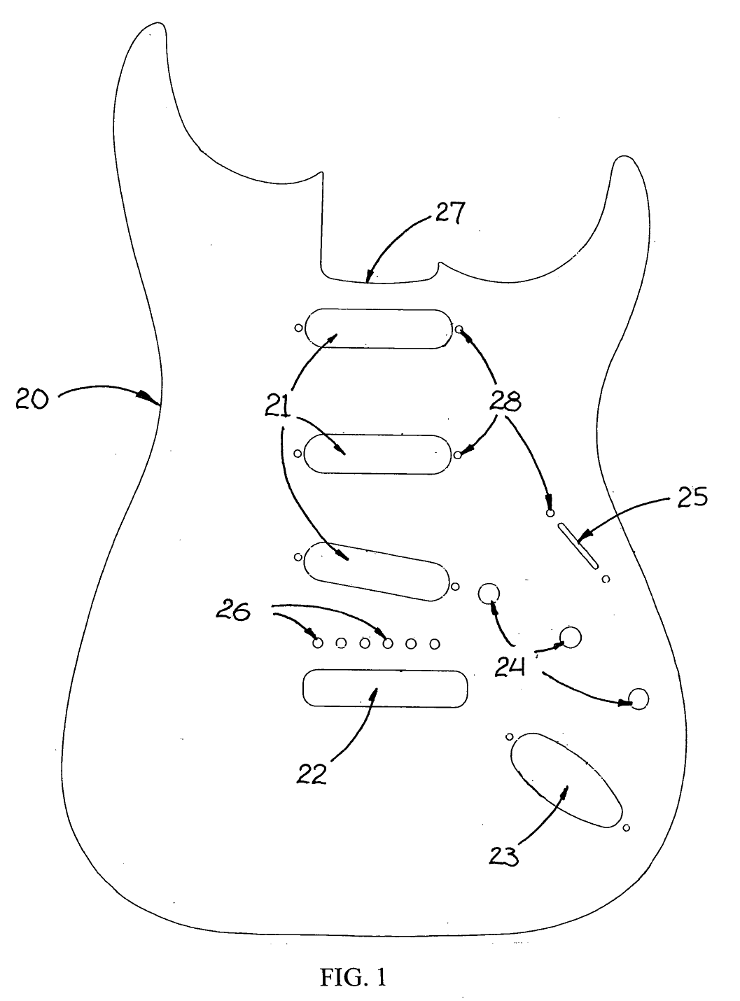

FIG. 1 shows a metal front deck plate 20 of the present invention for a guitar body of a solid-body type guitar. In the preferred embodiment, the metal plate 20 is 0.040 inches thick and is cut to the general contour of a finished guitar body, although to slightly smaller dimensions for placement within the body surface. Holes are cut into the plate to accommodate the pickups 21, strings 26, bridge 22, volume switches 24, and other electronic switches 25 and components 23. The metal plate 20 is made of aluminum, brass or other metal and is cut to the shape and thickness to be compatible with a particular guitar body shape. Two common models known in the art of guitar construction are solid body guitars, and hollow or semi-hollow guitar bodies. The metal plate 20 is preferably cut by a water jet cutting process that is well known in the art of metal fabrication, and is then finished with a brush or swirl pattern to enhance the metal plate's light reflective properties. After a desired finish is achieved, the metal plate 20 is prepared for assembly onto the bottom of the guitar body by grinding and sanding the back side of the plate 20 to maximize adhesion and to provide for a precise fit. Electronic components such as pickups are then mounted onto the metal plate by removable fasteners such as screws extended through holes 28 drilled through the metal plate surface. When assembling a hollow or semi-hollow guitar, the electronic components are mounted onto the metal plate 20 after the metal plate is attached to the sides and center block of the guitar body.

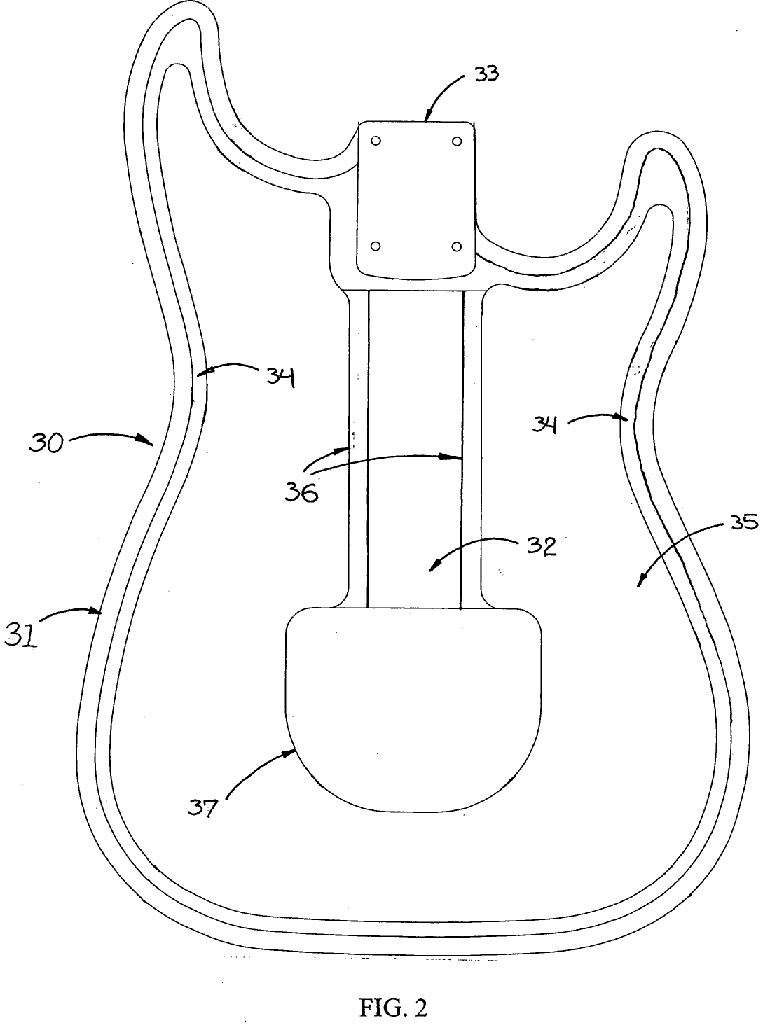

FIG. 2 shows the guitar body 30 of the solid-body type guitar showing the guitar body interior. A rabbet 34 is cut along the outer edge 31 of the guitar body to form a ledge in the inner body to accommodate the outer edge of the metal front plate 20. In the preferred embodiment, edge of the metal plate 20 is attached to the guitar body 30 by using a bead of flexible, temperature adjusted silicone or other flexible adhesive to secure the outer edge of the plate onto the ledge, and by fastening the top center of the metal plate 20 securely to a center block 32 by the bridge. Because the silicone adhesive provides a flexible means of attaching the metal plate 20 firmly into rabbet, and because the plate is rigidly connected only at its connection to the center block 32, the fastened metal plate 20 in a finished guitar is capable of resonating when the instrument is played, thus creating new and unique acoustic properties. A finished neck assembly is attached to the guitar body 30 at the location of a neck pocket 33.

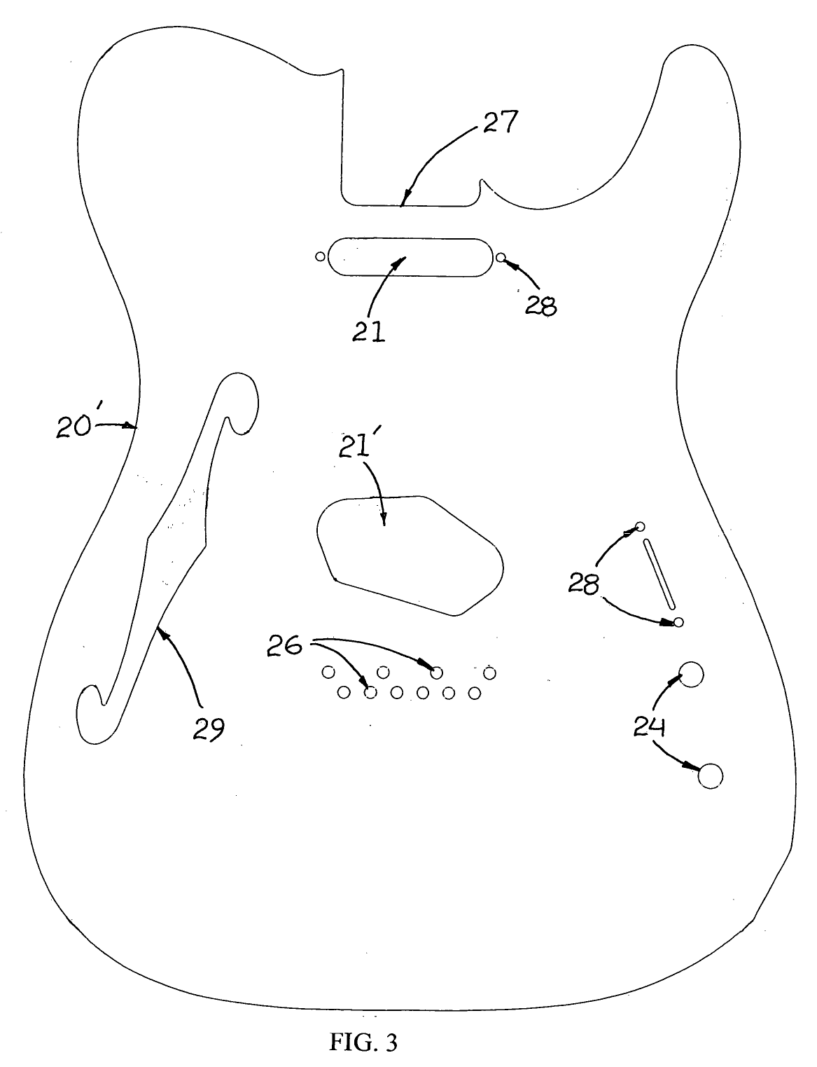

FIG. 3 shows a metal front deck plate 20 of the present invention for a guitar body of a hollow-body type guitar showing locations and orientation of holes for surface components on the metal front deck plate 20. In the preferred embodiment, the metal plate 20 is 0.040 inches thick and is cut to the general contour of the finished guitar body, although to slightly smaller dimensions. Holes are cut into the plate, such as the f-hole 29 and holes to accommodate the pickups 21 and 21′, strings 26, bridge 22, volume switches 24, and other electronic switches and components.

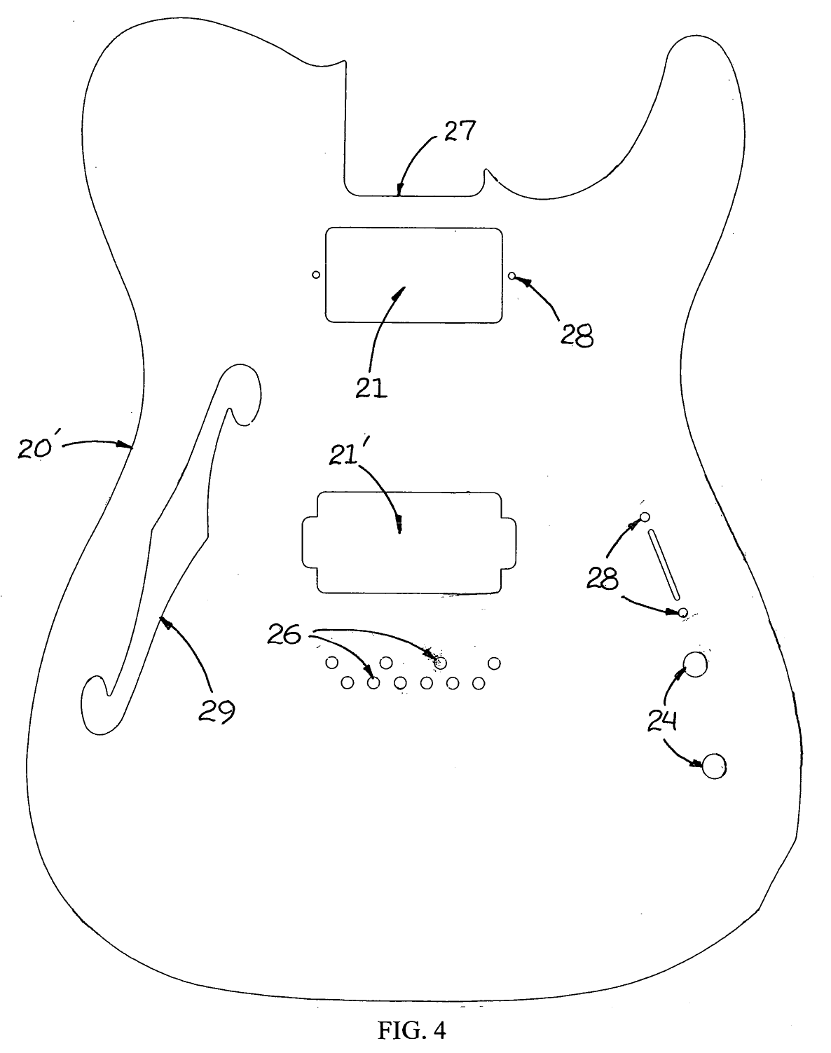

FIG. 4 shows another embodiment of a metal front deck plate 20′ of the present invention for a guitar body of a hollow-body type guitar. FIG. 4 illustrates that variations in the holes are possible to accommodate a variety of components including different pickups and electronic components and switches.

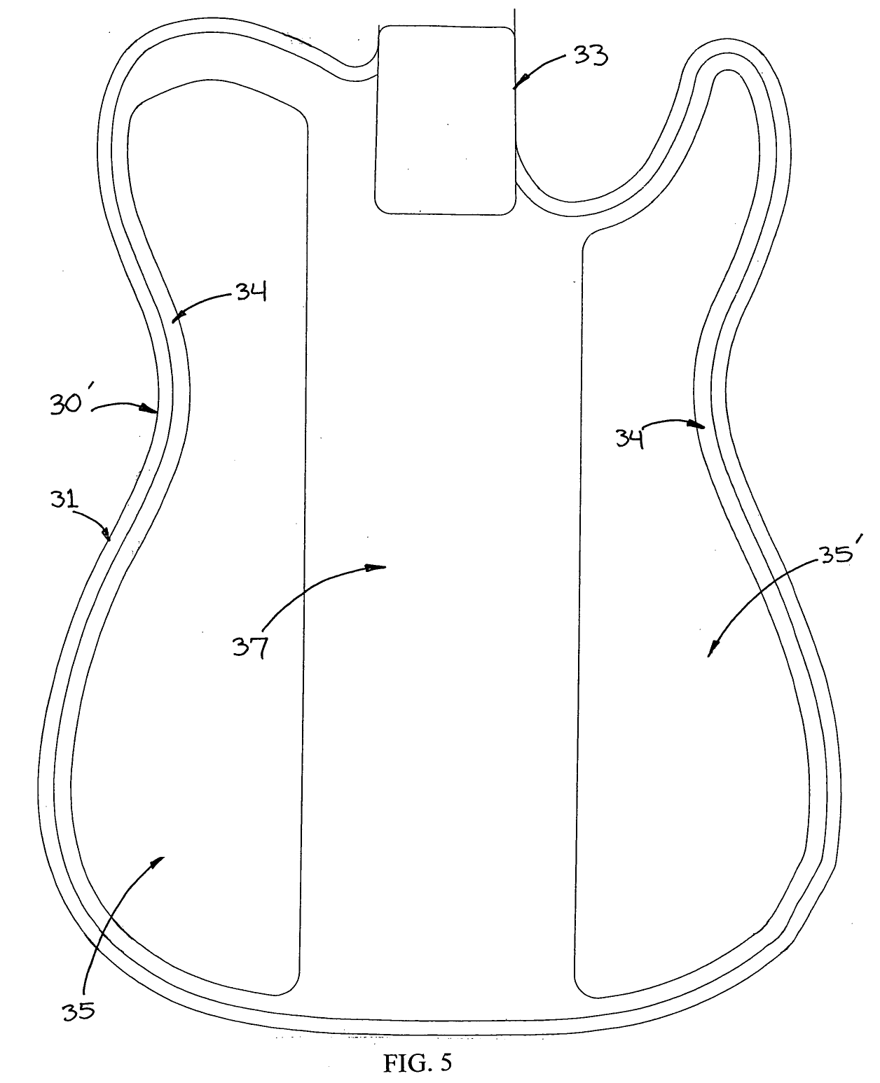

FIG. 5 shows a guitar body 31 of a hollow-body type guitar showing the guitar body interior. A rabbet 34 is cut along the outer edge of the guitar body 31 to form a ledge in the inner body to accommodate the outer edge of the metal front plate 20′. In the preferred embodiment, the metal plate 20′ is attached to the guitar body 30 by using a bead of flexible, temperature adjusted silicone adhesive to secure the outer edge of the plate onto the rabbet 34, and by fastening the top center of the metal plate 20 securely to a center block 32 by the bridge. Because the silicone adhesive provides a flexible means of attaching the metal plate 20′, and because the plate is rigidly connected only at its connection to the center block 32, the fastened metal plate 20′ in a finished guitar is capable of resonating when the instrument is played, thus creating new and unique acoustic properties. A finished neck assembly is attached to the guitar body 31 at the location of a neck pocket 33.

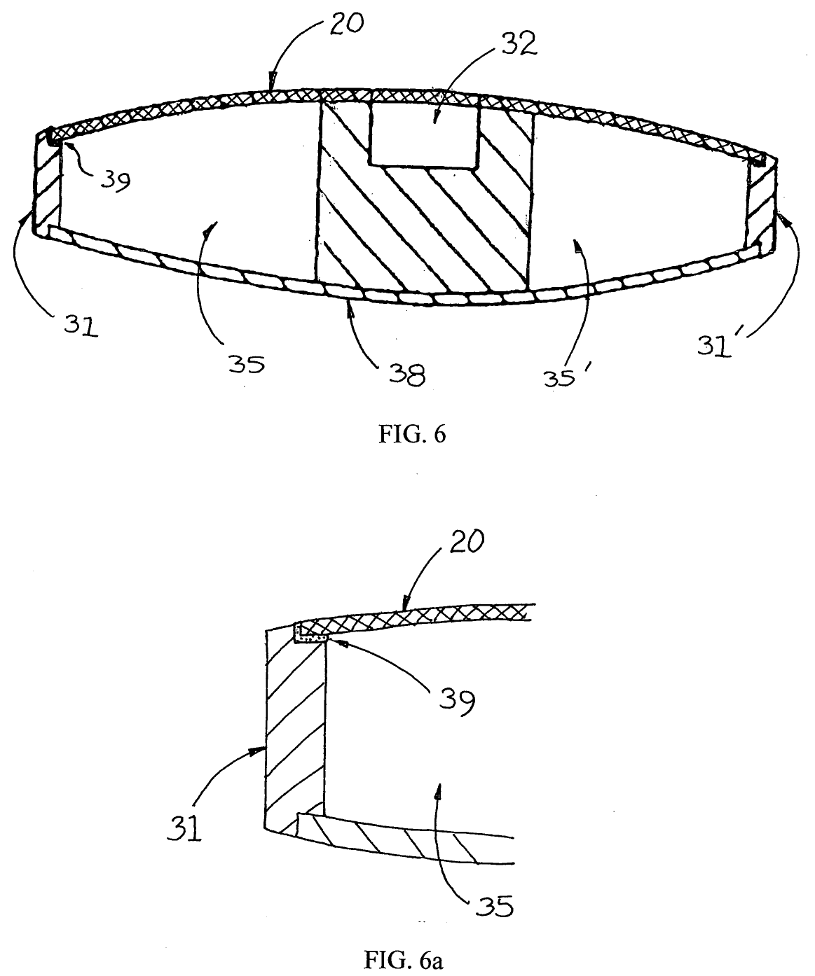

FIGS. 6 and 6a illustrate the connection of a metal front deck plate 20 to a hollow recess 34 of an outer edge 31 of a guitar body 30. In the preferred embodiment, the outer edge of the metal front deck plate 20 is attached to the hollow recess of the guitar body by means of a bead of flexible, temperature adjusted silicone adhesive 39. The metal plate 20 is securely affixed to the bridge 32 of the guitar body using adhesive or common fasteners. The silicone adhesive 39 is applied during the assembly process when the metal plate 20 is fitted onto the remainder of the guitar body assembly and preferably extends around the edge of the metal plate 20 to separate the plate 20 from the structure of the guitar frame. The silicone adhesive is allowed to cure for twelve to twenty-four hours while the plate 20 is held in position at key pressure points along the plate perimeter by clamps or weights. Additional silicone is added to any cavity that forms along the edge of the installed plate in order to fully isolate the plate and provide a seal along the outer perimeter of the plate resulting in a more uniform surface contour.

In the preferred embodiment, a guitar of the present invention is constructed by the following method:

1) A design is first selected for the type of guitar desired, and are commonly selected from among solid-body types and hollow or semi-hollow body types;

2) A desired building material is selected from various wood types to synthetic plastics and other moldable materials;

3) Selected building materials are cut to dimensions required for the selected guitar design;

4) Guitar body parts, including a body frame, a center block, a back deck plate, are assembled using commonly known methods and techniques;

5) A hollow recess is cut along the outer edge of the guitar body to form a ledge in the inner body to accommodate the outer edge of a front deck plate;

6) A metal front deck plate insert material is selected from a variety of materials such as silver, gold, brass, copper, and aluminum;

7) A metal plate is cut from the selected material to a size and shape specified by the guitar body design;

8) The metal plate is given a surface finish with a brush or swirl pattern to enhance the metal plate's light reflective properties;

9) After a desired finish is achieved, the metal plate is prepared for assembly onto the lower guitar body assembly by grinding and sanding the back side of the plate to maximize adhesion and to provide for a precise fit;

10) If the guitar design is a solid-body guitar, electronic components such as pickups are mounted onto the metal plate (before the plate is attached to the guitar body assembly) using removable fasteners such as screws extended through holes drilled through the metal plate surface;

11) If the guitar design is a hollow or semi-hollow guitar, the electronic components are mounted onto the metal plate after the metal plate is attached to the guitar body assembly;

12) The metal plate is attached to the guitar body assembly by using a bead of flexible, temperature adjusted silicone adhesive to secure the outer edge of the plate onto the ledge, and by fastening the top center of the metal plate securely to a center block; the silicone adhesive is allowed to cure while the plate is held in position at key pressure points along the plate perimeter by clamps or weights;

13) Additional silicone is added to any cavity that forms along the edge of the installed plate in order to provide a seal along the outer perimeter of the plate and to provide a more uniform surface contour;

14) A neck having a common fingerboard is constructed by methods and techniques commonly known in the art of guitar building, and is fastened to the completed guitar body, and guitar strings are mounted;

15) Paint and other desired finishes can be applied at any step in the process where practicable.

### INDUSTRIAL APPLICABILITY

The present invention has applicability to the field of stringed musical instruments, and more particularly to a guitar having a body with a metal front deck plate insert, and a method for its construction.

In compliance with the statute, the invention has been described in language more or less specific as to the design and construction of guitars. It is to be understood, however, that the invention is not limited to the specific means or features shown or described, since the means and features shown or described comprise preferred ways of putting the invention into effect.

Additionally, while this invention is described in terms of being used for electric guitars, it will be readily apparent to those skilled in the art that the invention can be adapted to other uses for musical instrument construction as well, stringed instruments and other instruments where acoustic aesthetic qualities can be enhanced, and therefore the invention should not be construed as being limited to electric guitar applications. The invention is, therefore, claimed in any of its forms or modifications within the legitimate and valid scope of the appended claims, appropriately interpreted in accordance with the doctrine of equivalents.

1. A stringed musical instrument having a body, a neck connected to the body, a fingerboard disposed upon the neck, a plurality of strings extending from the body over the fingerboard and to a location substantially at an end of the neck opposite the body, the body comprising:
a base assembly having a back section, a peripheral wall communicating with the back section and defining an overall shape of the body, a center block located between and substantially at the center of the back section, a recess disposed within the peripheral wall; and
a front section comprised of a metal deck plate having an outer surface and a perimeter edge that is flexibly attached to a ledge formed by said recess and a center portion that is securely attached to the center block;
whereby the metal deck plate resonates when the strings of the musical instrument are played, and the outer surface of the metal deck plate reflects light to produce a desirable visual quality of the musical instrument.

2. The stringed musical instrument of claim 1, wherein the base assembly of the body is formed from a solid piece of material selected from a group consisting of wood, metal, alloy and synthetic resin.

3. The stringed musical instrument of claim 1, wherein the base assembly of the body is at least partially hollow, is formed of material selected from a group consisting of wood, metal, alloy and synthetic resin, and further comprises:
a hollow interior space located between the back section and the front section, an internal frame disposed within the hollow interior space and connected to the back section, the peripheral wall, and the center block;
whereby, the hollow interior space produces a desired resonance when the strings of the musical instrument are played.

4. The musical instrument of claim 1 wherein said metal deck plate is comprised of an outer surface having a swirl pattern, whereby the outer surface of the metal deck plate reflects light in random patterns to produce a constantly changing visual quality of the musical instrument.

5. The musical instrument of claim 1 wherein said metal deck plate is comprised of an outer surface having a brushed pattern, whereby the outer surface of the metal deck plate reflects light in random patterns to produce a constantly changing visual quality of the musical instrument.

6. The body of the stringed musical instrument of claim 1, wherein the metal deck plate is flexibly attached to the hollow recess disposed within the peripheral wall using a bead of flexible, temperature controlled adhesive.

7. An electric guitar having a body, a neck connected to the body, a fingerboard disposed upon the neck, a plurality of strings extending from the body over the fingerboard and to a location substantially at an end of the neck opposite the body, the body comprising:
a base assembly having a back section, a peripheral wall communicating with the back section and defining an overall shape of the body, a center block located between and substantially at the center of the back section, a rabbet disposed within the peripheral wall; and
a front section comprised of a metal deck plate having an outer surface and a perimeter edge that is flexibly attached to said rabbet using a bead of flexible, temperature controlled adhesive, and a center portion that is securely attached to the center block;
at least one pickup for detecting sound vibrations initiated by the strings and converting them to electrical signals corresponding to the sound;
electronic controls for controlling volume and other sound characteristics; and
an electrical interface for providing the electrical signals to an amplifier;
whereby the metal deck plate resonates when the strings of the musical instrument are played, the sound vibrations resulting therefrom are available for amplification, and the outer surface of the metal deck plate reflects light to produce a desirable visual quality of the musical instrument.

8. The electric guitar of claim 7, wherein the base assembly of the body is formed from a solid piece of material selected from a group consisting of wood, metal, alloy and synthetic resin.

9. The electric guitar of claim 7, wherein the base assembly of the body is at least partially hollow, is formed of material selected from a group consisting of wood, metal, alloy and synthetic resin, and further comprises:
a hollow interior space located between the back section and the front section, an internal frame disposed within the hollow interior space and connected to the back section, the peripheral wall, and the center block;
whereby, the hollow interior space produces a desired resonance when the strings of the musical instrument are played.

10. The metal deck plate of claim 7 comprised of an outer surface having a swirl pattern, whereby the outer surface of the metal deck plate reflects light in random patterns to produce a constantly changing visual quality of the musical instrument.

11. The metal deck plate of claim 7 comprised of an outer surface having a brushed pattern, whereby the outer surface of the metal deck plate reflects light in random patterns to produce a constantly changing visual quality of the musical instrument.

12. A method for constructing a body of a guitar and other stringed musical instruments having a metal front deck plate insert for providing desirable acoustic properties and an aesthetic appearance, the method comprising the steps of:
selecting a design for the type of instrument desired;
selecting a building material from various wood types, synthetic plastics and other moldable materials;
cutting the selected building materials to dimensions required for the selected instrument design;
fabricating instrument body parts such as a back section, a peripheral wall for communicating with the back section and defining an overall shape of the body, and a center block, using commonly known methods and techniques for building instruments, and combining them to form a body assembly;
selecting a desired metal front deck plate insert material is from a variety of metals such as silver, gold, brass, copper, and aluminum;
forming a hollow recess along the peripheral wall to form a ledge within a front surface of the body to accommodate an outer edge of a metal front deck plate;
cutting the metal deck plate from the selected material to a size and shape specified by the selected body design;
providing a surface finish for the metal deck plate, such as a brush or swirl pattern, to enhance the metal deck plate's light reflective properties;
preparing the metal deck plate for assembly onto the body assembly by grinding and sanding a back surface of the plate to maximize adhesion and to provide for a precise fit;
installing components, such as a bridge, pickups, and electrical controls, if required for the selected design, onto the metal deck plate and the body assembly;
attaching the metal deck plate to the body assembly by applying a bead of flexible, temperature adjusted silicone adhesive to flexibly attach a perimeter edge of the metal deck plate onto the ledge within the front surface of the body, and by fastening a center portion of the metal deck plate rigidly to a substantially central location on the body assembly;
allowing the silicone adhesive to cure while the metal deck plate is held in position at key pressure points along the perimeter edge, such as by clamps or weights;
applying additional silicone to a pot cavity along the perimeter edge of the metal deck plate following attachment to the body assembly to provide a seal along the perimeter edge of the metal deck plate and to provide a more uniform surface contour;
fastening a neck having a common fingerboard as constructed by methods and techniques commonly known in the art of guitar building, and is fastened to the completed guitar body, and installing a plurality of strings; and
applying paint and other desired finishing materials at any step in the process where practicable.

13. The musical instrument of claim 1 wherein said recess is formed as a rabbet in said peripheral wall.

14. The musical instrument of claim 1 wherein said recess is formed by cutting a groove into said peripheral wall.

15. The musical instrument of claim 1 wherein said metal deck plate is unitary.

16. The musical instrument of claim 7 wherein said recess is formed as a rabbet in said peripheral wall

17. The musical instrument of claim 7 wherein said recess is formed by cutting a groove into said peripheral wall.

18. The musical instrument of claim 7 wherein said metal deck plate is unitary.
